(19) United States
(12) Patent Application Publication
(10) Pub. No.: US 2007/0066370 A1
(43) Pub. Date: Mar. 22, 2007

(54) Air boost to improve straw chopper spreading in a combine harvester

(76) Inventors: Leo Redekop, Saskatoon (CA); Kevin Redekop, Saskatoon (CA); Dean Mayerle, Saskatoon (CA)

Correspondence Address: Ade & Company Inc., P.O. Box 28006, 1795 Henerson Highway, Winnipeg, MB, R2G0P1, CA

(21) Appl. No.: 10/571,098

(22) PCT Filed: Sep. 9, 2004
(86) PCT No.: PCT/CA04/01599

§ 371 Date: Nov. 7, 2006

(30) Foreign Application Priority Data
Sep. 9, 2003 (CA) 2,440,082

(51) Int. Cl. A01F 12/40

(52) U.S. Cl. 460/112

(57) ABSTRACT

A combine harvester with a straw separating system includes a straw chopper and discharge assembly mounted for receiving the straw and having a rotor for chopping the straw and for generating a stream of chopped straw for spreading the chopped straw. A pneumatic air source is provided preferably separately driven from and remote from the rotor for generating a stream of air having an outlet duct forming a stream of air. The air is used either to assist the spreading action from the chopper and can be individually controlled by valves. If used to assist the air stream of the chopper it is fed at the outlet of a rear chopper or directed at the guide wall in an internal chopper arrangement for directing higher velocity air onto the guide fins assisting the spread of the chopped materials.

### FIELD OF THE INVENTION

The present invention relates to a combine harvester and to the spreading of straw and/or chaff from the combine harvester using a fan to generate an airflow.

### BACKGROUND OF THE INVENTION

Axial flow combines have in recent years taken the vast majority of the market replacing older conventional designs. It is most cost effective in such axial flow combines to provide an internal straw chopper behind the axial flow rotors.

One example of an arrangement of this type is shown in U.S. Pat. No. 3,863,643 (De Pauw) issued Feb. 4, 1975 to International Harvester which shows a rotary beater transverse to the combine harvester behind the axial rotors. CaseIH produces an optional internal chopper, mounted in place of the rotary beater which feeds the straw onto a guide wall which extends across the width of the housing and the hood of the combine and then extends downwardly and rearwardly at the rear.

There is commonly used a rotary spreader disk at the rear end of the housing which accelerates the stream of chopped straw to discharge the material to the sides.

Combine development in recent years have put greater demands on the straw choppers and chaff spreaders. The main reasons are that larger combines and wider cutting widths are creating higher flows of straw and chaff; wider cutting widths create more demanding spreading widths; reduced tilling practices have put more demand on even spreading of both straw and chaff and that plant breeding has resulted in tougher straw, higher yields and more residue.

A number of different arrangements have been proposed to assist in spreading the straw at the rear of the guide wall and the housing and examples of these are as follows.

In U.S. Pat. No. 4,735,216 (Scott) issued Apr. 5, 1988 is proposed a pair of counter-rotating fans mounted in a horizontal plane for rotation about vertical axis which direct the, crop material to the sides.

In U.S. Pat. No. 6,663,485 (Niermann) issued Dec. 16, 2003 to Claas is disclosed a blower and spreading arrangement mounted at the rear of the housing which is intended to improve power efficiency.

In U.S. Pat. No. 5,232,405 issued Aug. 3, 1993 and U.S. Pat. No. 5,482,508 issued Jan. 9, 1996; one of the inventors herein Redekop discloses an improved rotor which includes a number of fan blades which assist in generating an enhanced air stream while chopping the straw. This arrangement has achieved considerable success.

Also in published US application 2004/0043804 published Mar. 4, 2004, Redekop et al. disclose a further improved arrangement in which the fan blades are located at respective ends of the rotor concentrating the cutting blades in a center section of the rotor. This arrangement has been shown to provide yet further advantages in generating an effective air stream while causing effective chopping of the straw.

While improvements to the construction of the rotor enhance the spreading action, there still remains some difficulties in obtaining an effective spread when using an internal chopper without the addition of further chopping action or spreading action at the rear of the guide wall. However enhanced efficiency in the chopping and spreading action is required to reduce power consumption, bearing in mind that power requirements for the operation of the remaining elements of the combine harvester are increasing due to the features set forth above.

It is known also to provide additional airflow into the chopper in an attempt to increase spreading action. For example U.S. Pat. No. 6,113,491 (Holmen) issued Sep. 5, 2000 to Rekordverden discloses an arrangement in which an additional fan is located at the end of the chopper rotor and generates an air stream which is driven into the area of the rotor at a position angularly ahead of the discharge area. This arrangement has not achieved significant success.

EP 1187526 (Schratteneker) published 3 Sep. 2003 discloses a straw chopper with fans mounted to each side of the chopper each having a pivotal nozzle which allows the air jet to be directed at various positions on each outer fin only of the tailboard.

US Application 2004/0137974 (Weichholdt) of Deere and Company discloses a combine harvester with a chopper under the beater at the rear of the threshing rotor where the arrangement can be adjusted to by-pass the chopper.

### SUMMARY OF THE INVENTION

It is an objective of the invention to provide an improved straw discharge system for a combine harvester.

According to a first aspect of the invention there is provided a combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream of chopped straw for spreading the chopped straw;
the chopper and discharge apparatus having:
   a rotor mounted for rotation about a longitudinal axis of the rotor and a plurality of blade members mounted on the rotor for rotation therewith about said axis for chopping the straw and accelerating the chopped materials in a stream for discharge at a discharge location;
   a plurality of guide fins at the discharge location for directing the chopped materials into a spread pattern;
   and a pneumatic air source for generating a stream of air through an outlet opening of an outlet nozzle forming a stream of air directed at a plurality of the guide fins for assisting the spread of the chopped materials.

Preferably the stream of air is arranged such that the velocity of the air is different at different ones of the guide fins.

Preferably herein the stream of air is adjustable at different positions across the stream.

Preferably there are provided two separate nozzles each having an outlet opening directed at a plurality of guide fins at a respective side of the discharge location.

Preferably each nozzle defines a slot shaped opening having a width sufficient to direct air onto a plurality of the guide fins.

Preferably the nozzle includes a slot shaped opening located so as to extend across a part of the stream of chopped material.

Preferably the pressure and/or flow of the air source are remotely controlled.

Preferably the exit air velocity at the outlet opening is controlled.

Preferably the outlet opening of the nozzle is mounted immediately adjacent the guide fins for directing the air stream onto the fins.

In one arrangement, the rotor is an internal rotor within the combine housing and there is provided a guide wall extending from the rotor to the discharge location where the guide fins are located and wherein the nozzle opening is mounted at a location adjacent the fins.

The nozzle may be located above the guide wall so as to direct the air into the stream of chopped material from above the stream. However it may be desirable to mount the nozzle below the stream to apply air tending to press the stream against the guide wall. Alternatively there may be two nozzles mounted n respective sides to the stream.

In one arrangement, the rotor includes two end fan sections wherein each end fan section communicates air therefrom through a duct alongside the guide wall to a separate nozzle.

The nozzle may include. a plenum defined above the guide wall wherein one side of the plenum is defined by the guide wall with the nozzle defined at a step in the guide wall. However alternative arrangements below the guide wall can also be used.

Preferably the guide wall and the fins are arranged to include a movable element arranged to be movable from a first position directing the straw onto the fins to a second position directing the straw to by-pass the fins.

Preferably the movable element comprises a panel of the guide wall which is mounted for pivotal movement about a transverse axis at a leading edge of the panel so as to move a trailing edge thereof.

Preferably the panel is arranged in advance of the nozzle.

Preferably the rotor is mounted in a rotor housing at the rear of the combine for discharge of the material from the rotor housing onto a tailboard located behind the rotor housing and wherein the nozzle is defined by a plenum carried on the rotor housing.

Preferably the plenum carried on the rotor housing is fed centrally of the rotor housing by a duct from the air source. However there may be two separate nozzles each fed separately from a separate aid source and each arranged on a respective side.

Preferably the plenum includes guide walls dividing the plenum into two separate paths for the air each feeding a separate one of two nozzles each arranged adjacent a respective side of the rotor housing.

In another arrangement, the rotor is mounted in a rotor housing at the rear of the combine for discharge of the material from the rotor housing onto a tailboard located behind the rotor housing and wherein the nozzle provides at least one slot shaped opening extending across the rotor housing for adding air into the stream emerging from the rotor housing.

According to a second aspect of the invention there is provided a combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream chopped straw for spreading the chopped straw;
the chopper and discharge apparatus having:
   an internal rotor within the combine harvester mounted for rotation about a longitudinal axis of the rotor and a plurality of blade members mounted on the rotor for rotation therewith about said axis for chopping the straw and accelerating the chopped materials in a stream for discharge at a discharge location;
   a guide wall extending from the rotor to the discharge location;
   a plurality of guide fins at the discharge location for directing the chopped materials into a spread pattern;
   and a pneumatic air source for generating a stream of air through an outlet opening of an outlet nozzle for assisting the spread of the chopped materials;
wherein the nozzle is mounted at a location adjacent the fins and forming a stream of air directed at a plurality of the guide fins.

According to a third aspect of the invention there is provided a combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream of chopped straw for spreading the chopped straw;
the chopper and discharge apparatus having:
   a rotor mounted for rotation about a longitudinal axis of the rotor and a plurality of blade members mounted on the rotor for rotation therewith about said axis for chopping the straw and accelerating the chopped materials in a stream for discharge at a discharge location;
   the rotor being mounted in a rotor housing at the rear of the combine for discharge of the material from the rotor housing onto a tailboard located behind the rotor housing;
   a plurality of guide fins at the tailboard for directing the chopped materials into a spread pattern;
   a pneumatic air source for generating a stream of air;
   and a plenum mounted on the rotor housing for receiving the stream of air and defining an outlet nozzle having an outlet opening directed the guide fins for assisting the spread of the chopped materials.

According to a fourth aspect of the invention there is provided a combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream of chopped straw for spreading the chopped straw;
the chopper and discharge apparatus having:
   a rotor mounted for rotation about a longitudinal axis of the rotor and a plurality of blade members mounted on the rotor for rotation therewith about said axis for chopping the straw and accelerating the chopped materials in a stream for discharge at a discharge location;
   the rotor being mounted in a rotor housing at the rear of the combine for discharge of the material from the rotor housing onto a tailboard located behind the rotor housing;
   a plurality of guide fins at the tailboard for directing the chopped materials into a spread pattern;
   a pneumatic air source for generating a stream of air;
   and a plenum for receiving the stream of air and defining an outlet opening of an outlet nozzle directed at the guide fins for assisting the spread of the chopped materials.
wherein the outlet opening is slot shaped extending across the rotor housing for adding air into the stream emerging from the rotor housing.

According to a fifth aspect of the invention there is provided a combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream of chopped straw for spreading the chopped straw;
the chopper and discharge apparatus having:
   an internal rotor within the combine harvester mounted for rotation about a longitudinal axis of the rotor and a plurality of blade members mounted on the rotor for rotation therewith about said axis for chopping the straw and accelerating the chopped materials in a stream for discharge at a discharge location;
   a guide wall extending from the rotor to the discharge location;
   a plurality of guide fins at the discharge location for directing the chopped materials into a spread pattern;
wherein the guide wall and the fins are arranged to include a movable element arranged to be movable from a first position directing the straw onto the fins to a second position directing the straw to by-pass the fins.

It is also intended that the protection provided by this application should extend to the elements necessary to mount the components on an existing combine harvester having a chopper and fins.

### BRIEF DESCRIPTION OF THE DRAWINGS

Embodiments according to the present invention will now be described in conjunction with the accompanying drawings in which:

FIG. 1 is schematic isometric view of the rear section of a rotary combine including the combine rotor, a straw chopper and a discharge guide system for the straw discharged from the chopper, all showing a first embodiment of the present invention.

FIG. 2 is a schematic top plan view of the embodiment of FIG. 1.

FIG. 3 is an isometric view similar to that of FIG. 1 but with the guide surfaces shown in full line. rather than in phantom.

FIG. 4 is a side elevational view, partly in phantom showing the embodiment of FIG. 1 arranged for spreading of the straw.

FIG. 5 is a side elevational view similar to that of FIG. 4 on an enlarged scale showing adjustment of a guide wall to avoid spreading of the straw.

FIG. 6 is an isometric view partly in phantom showing the air control plenum for mixing the air and straw stream.

FIG. 7 is a side elevational view similar to that of FIG. 4 showing a modified arrangement utilizing a separate fan for injecting into the nozzle of FIG. 6.

FIG. 8 is a side elevational view partly in phantom of a further embodiment utilizing an external chopper at the rear of the combine in which air is injected immediately downstream of the chopper.

FIG. 9 is a side elevational view partly in phantom of the embodiment of FIG. 8 on an enlarged scale.

FIG. 10 is a top plan view of the embodiment of FIG. 8, again partly in phantom.

FIG. 11 is an isometric view from the rear and one side of the embodiment of FIG. 8.

FIG. 12 is a rear elevational view of the embodiment of FIG. 8.

FIG. 13 is an isometric view of the air injection manifold separated from the embodiment of FIG. 8.

In the drawings like characters of reference indicate corresponding parts in the different figures.

### DESCRIPTION OF THE PREFERRED EMBODIMENTS

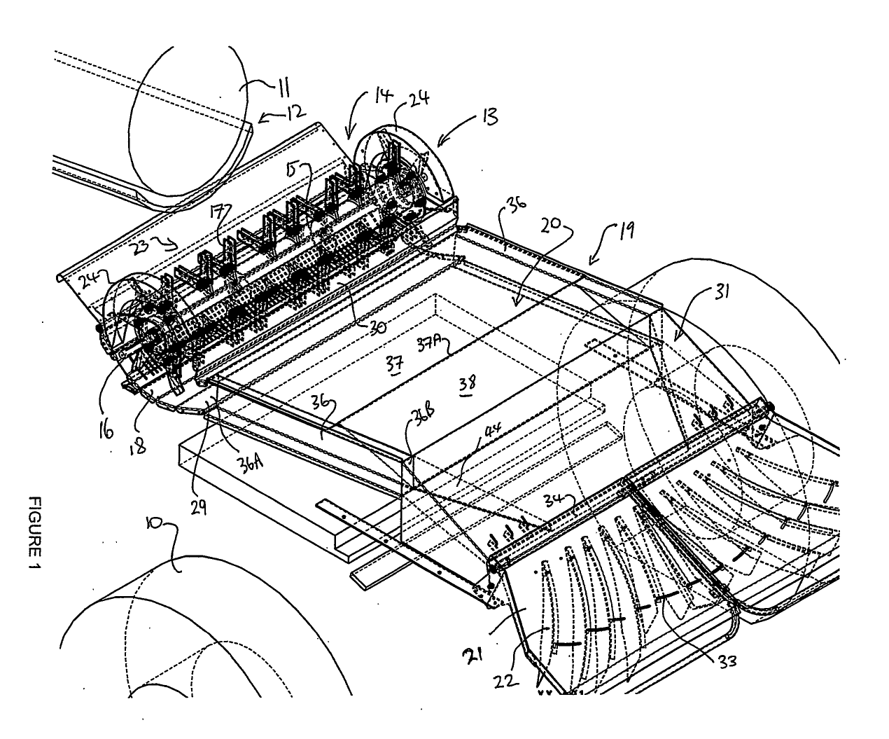

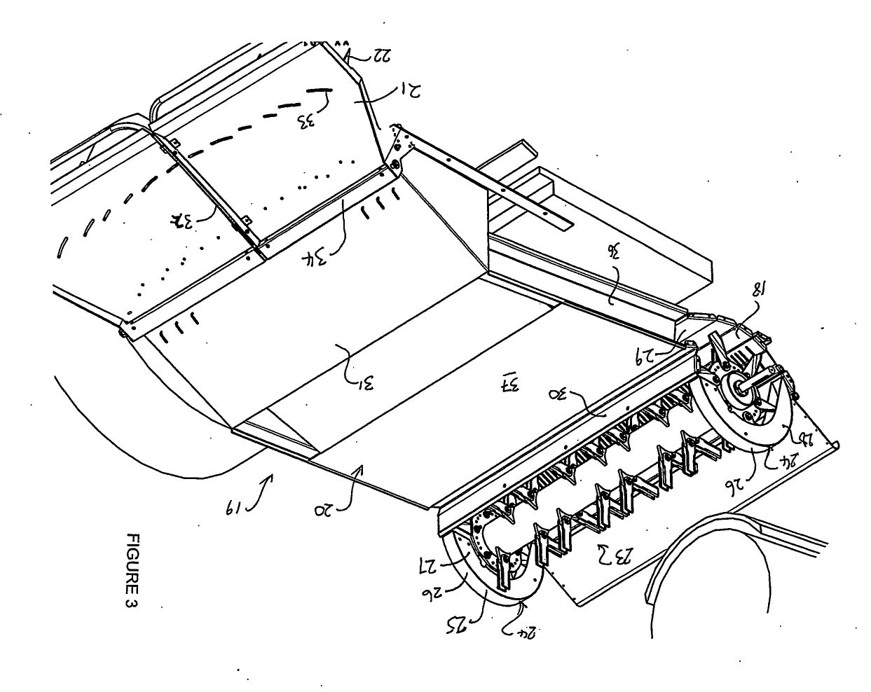

In FIGS. 1 through 6 is shown a first embodiment of the invention in which the relevant components of a combine harvester have been extracted and are shown in phantom.

The combine harvester thus includes a housing (not shown) mounted on rear ground wheels 10 supporting the various components of the combine harvester. A combine harvester of this general type is shown in U.S. Pat. No. 3,863,643 previously mentioned, the disclosure of which is incorporated herein by reference. The combine harvester includes a threshing rotor 11 which operates to separate harvested materials from the straw and discharges the straw at a rear end 12 of the rotor into a straw chopping and discharge system generally indicated at 13.

It is conventional that the discharge system 13 includes a rotor 14 which is mounted on a shaft 15 for rotation about a horizontal axis across the rear of the threshing rotor 11. The chopping rotor is driven in rotation around the axis of the shaft by a drive mechanism mounted on the end of the shaft exposed at 16 with a drive mechanism being omitted for convenience of illustration. The rotor carries pairs of blades 17 at spaced positions around the axis of the rotor and at spaced positions along the axis of the rotor so that the straw emerging from the rear of the threshing rotor 11 is chopped and is accelerated underneath the rotor 14 over a guide surface 18 into a guide and spreading component generally indicated at 19. This includes a guide wall 20 which carries the straw material rearwardly onto a tailboard 21 carrying a series of fins 22 at spaced positions across the tailboard. The fins 22 are curved rearwardly and outwardly so that outermost ones of the fins are directed at greater angles to a longitudinal centerline than are center ones of the fins so as to provide a spread pattern of the chopped straw across the ground.

The components described above are generally conventionally used in combine harvesters of this general type but in the arrangement described herein are modified as described hereinafter. The rotor 14 is of the type shown in US application 2004/0043804 published Mar. 4, 2004, Redekop et al., the disclosure of this patent is incorporated herein by reference.

Thus the rotor 14 is divided into a center section generally indicated at 23 between two end sections 24. The end sections contain blades on the hub of the rotor which are shaped to provide a fan effect whereas the blades in the center section 23 are primarily or wholly cutting blades and thus are substantially flat in radial planes of the rotor. Thus the cutting action occurs primarily in the center section and the two end sections are arranged primarily for generating airflow.

In the above stated previous published application, air transferred and material transferred between the center section and the end sections is possible so that some straw may enter the end sections and some air may be driven from the end sections into the center section. In the present arrangement, the intention is that the sections are maintained substantially or wholly separate so that no straw enters the end sections 24 and no air migrates from the end sections 24 into the center section. Thus substantially the whole of the air from the end sections 24 is available for air propulsion as described hereinafter.

For this reason, covers 25 are provided over the end sections including a part cylindrical outer wall 26 and a part annular side walls 27 and 28. These walls act to prevent the transfer as set forth above or at least to inhibit the majority of the transfer.

The end and center sections rotate commonly on the common hub and thus generate a stream of the material discharging from a nozzle 29. For this reason the rotor is confined at the bottom by the bottom wall 18 and is confined over the top by suitable guide components including bottom panel 30 so that the nozzle 29 is defined between the rear edge of the bottom wall 18 and the bottom of the panel 30.

The guide system 19 defined by the walls generally indicated at 20 carries the straw from the center section 23 and the air from the end sections 24 and transports these independently to a plenum generally indicated at 31 after which the air and straw are remixed for entry onto the tail board 21 and the fins 22.

The fins are basically of a conventional nature which are mounted on the underside of the tail board and are provided with curvature to provide a spread pattern. The inclination of the fins relative to a center line of the tailboard indicated at 32 can be adjusted by moving a mounting bolt of each fin along a slot 33 of the fin on the tailboard.

In conventional manner, the tailboard is mounted at its forward end on a transverse pivot mounting generally indicated at 34 which allows the inclination of the tailboard to be adjusted about a horizontal axis on a mounting bracket 35.

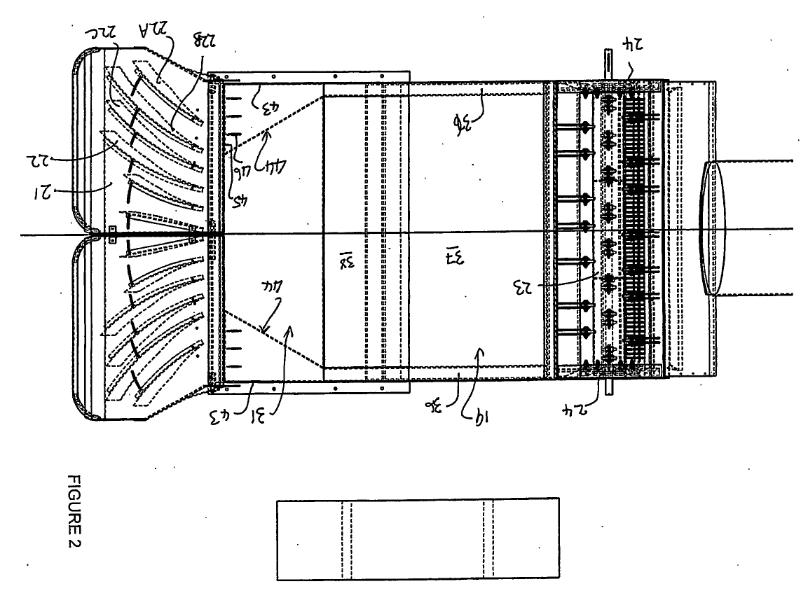

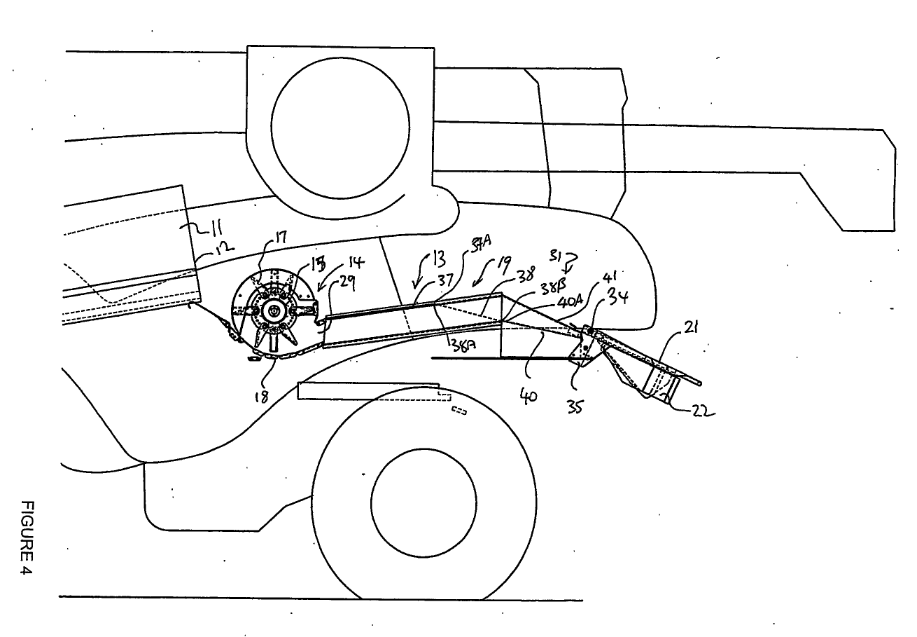

The guide system 19 as best shown in FIGS. 2 and 4 includes two guide ducts 36 which have a width equal to the end sections 24 of the chopper rotor so as to receive air directly therefrom and carry that air rearwardly along the guide 19 to the plenum 31. Each of the ducts 36 is confined by two side walls, a top wall and a bottom wall so as to form a closed duct of rectangular cross section having an open mouth 36A at the nozzle 29 and an open mouth 36B at the plenum 31. An inside side wall of the duct 36 is formed by sheet metal component of the guide walls 20 and an outside wall can be formed by a wall of the housing of the combine and thus is not visible in the figures.

In between the ducts 36, the guide system is defined by a top wall 37 of the walls 20 which extends across the top of the ducts 36 and thus forms a channel shaped area between the ducts 36 and underneath the top wall 37 into which straw is ejected from the outlet nozzle 29. The straw is injected in a stream from the outlet nozzle 29 upwardly and rearwardly so as to impact the surface 37 so as to be guided thereby a movement along the surface 37 upwardly and rearwardly toward the plenum 31 and the tailboard 21.

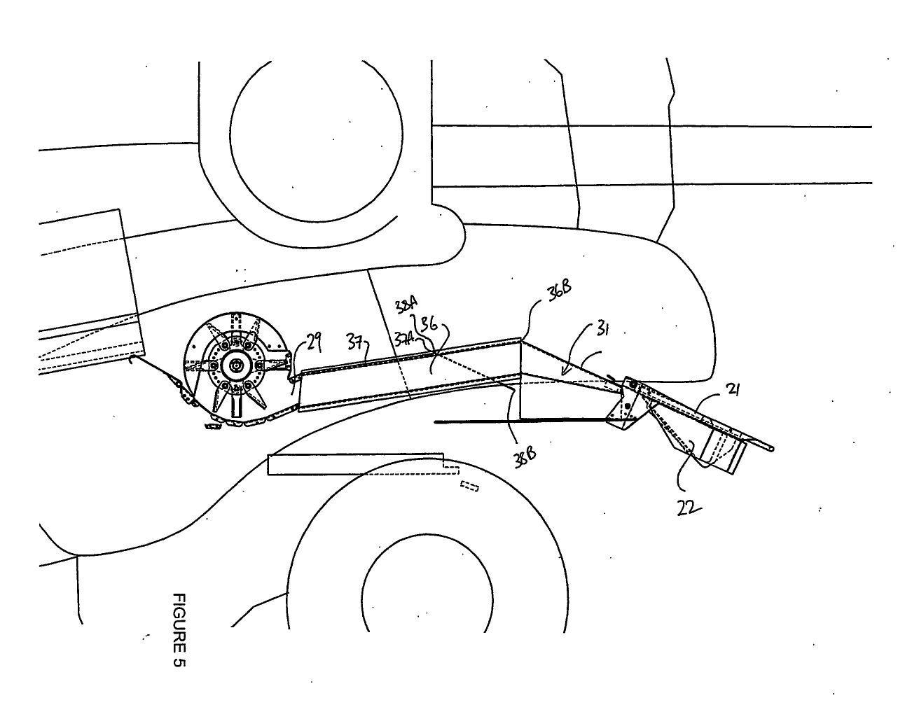

Thus the straw exiting from the nozzle 29 across the full width of the center section 23 is guided rearwardly between the ducts 36 across the walls 37. The wall 37 has a rear edge 37A which is spaced forwardly of the rear mouth 36B of the ducts 36. AT the rear edge 37A is mounted a pivotal panel 38 which has a leading edge 38A at the rear edge 37A at which the panel is mounted for pivotal movement about the horizontal axis defined transversely of the guide system 19 at the rear edge 37A. The panel 38 thus has a trailing edge 38B which can be moved from a first position shown in FIG. 4 to a second downwardly inclined position shown in FIG. 5.

In the position shown in FIG. 4, the panel 38 extends downwardly and rearwardly to take up a position where its rear edge 38B is contiguous with a front edge 40A of a bottom panel 40 of the plenum 31. Thus the crop material sliding over the bottom surface of the wall 37 enters onto the bottom surface of the wall 38 and transfers therefrom to the bottom surface of the wall 40. The crop material in its chopped condition thus passes over these surfaces and ends up on the bottom surface of the tailboard 21 which is inclined slightly downwardly relative to the downward inclination of the walls 38 and 40. Thus the crop stream is smoothly carried over the surfaces and onto the under surface of the tailboard where it encounters the fins 21 and is divided into the separate streams which are spread by the orientation of the fins in conventional manner.

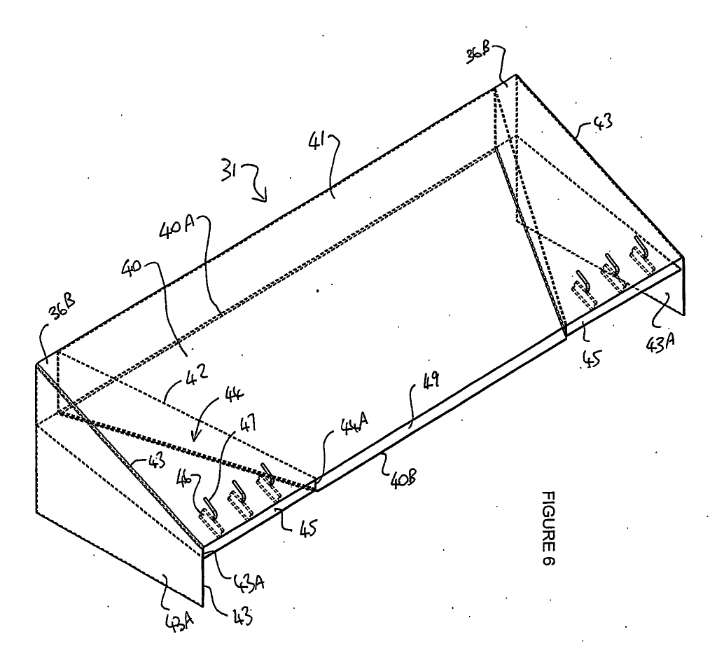

The airstream emerging from the rear open ends 36B of the ducts 36 enters into the plenum 31 as best shown in FIG. 6 at a position above the wall 40 and underneath the top wall 41 of the plenum. Between the top and bottom walls 40 and 41 is defined a pair of upstanding side guide walls 42 and 43 defining a nozzle 44 within the plenum 31 for the air emerging from the duct 36. The nozzle 44 is defined between the walls 42 and 43 with the wall 43 arranged along one side of the plenum 41 and the wall 44 inclined inwardly so that it terminates at a trailing edge 44A spaced from the trailing edge 43A of the wall 43 by a distance greater than the width of the duct 36. At the same time as the nozzle increases in width, it also reduces in height so that the wall 41 approaches the wall 40 leaving a slot shaped open mouth 45 at the trailing end of the nozzle 44. The opening 45 has a height defined by the spacing between the walls 40 and 41 and a width defined by the spacing between the walls 43 and 44. Thus the air stream entering the nozzle 44 is transferred in air stream shape from the relatively high duct 36 to the shallow wider nozzle mouth 45.

Adjacent the mouth 45, the nozzle 44 has a plurality of butterfly valves 46 which can be adjusted by rotation of each of the valves about an axis through the wall 41 and a control of a manually operable lever 47. Each of the valves 46 can be adjusted independently so as to vary the amount of air emerging at different positions across the width of the mouth 45. In the position shown, the valves have their valve surface generally parallel to the air stream so that they have little or no effect on the movement of the air. However it will be appreciated that rotation of the valve through 90° will close off that particular portion of the mouth 45 thus redirecting the air to another portion of the mouth 45. In this way individual adjustment of the valves 46 can control the amount of air exiting at required positions through the mouth 45 onto the tailboard 21.

It will be appreciated therefore that the straw flowing underneath the wall 40 exits a trailing edge 40B of the wall 40 and transfers therefrom over a slight step defined by the height of the nozzle mouth 45 and a blanking wall piece 49 between the mouths 45 onto the surface of the tailboard. As the crop material bridges this step, the air stream from the mouths 45 joins with the straw to form a combined stream. It will be appreciated that the straw or crop material at the center adjacent the blanking wall 49 contains less of the air from the ducts 44 and thus is carried primarily by the air from the rotor 14. Additional air is added into the crop stream as it passes underneath the mouth 45 so the side portions of the crop stream are supplemented by the additional air from the ducts 36.

It will be appreciated that the crop stream is confined at the trailing edge 40B by the walls 43 and particularly a depending portion 43A thereof underneath the trailing edge 40B. The walls 43 are spaced by a greater distance than the width of the panel 37 and the panel 38 since they also include the width of the ducts 36. Thus the straw initially confined between the inside walls of the ducts 36 is allowed to spread out at the rear end of the ducts 36 into the area confined between the walls 43. The pressure within the stream tends to cause this spread so that the straw takes up a substantially constant quantity across the full width between the walls 43 at the end of the plenum 41.

The straw is thus guided by the walls 43 onto the tailboard at a position outboard of the outermost fin indicated at 22A. It will be noted from FIG. 2 that the width of the mouth 45 defined by the walls 43 and 44 causes the air stream to enter into the leading end of the first three fins indicated at 22A, 22B and 22C respectively. Thus each of these fins has the stream of material thereon supplemented by air from the mouth 45. As previously stated the particular amount of air directed to each of the fins can be adjusted by operation of the respective valve 46.

As the remaining fins inboard of the third fin 22C are spaced inward from the mouth 45, they receive little supplemental air from the duct 36.

Thus the supplemental air stream from the ducts 36 is transferred into the stream of straw or crop material on the tail board substantially immediately at the entry onto or at the leading edge of the tailboard at the step defined by the mouth 45 and the plate 49. Thus the supplemental air is confined to the outermost fins and particularly the outermost three fins where enhanced spreading action is particularly required. It has been found that adding supplemental air to the materials flowing on the three outermost fins causes the best spreading action and the best accuracy of distribution across the full width of the spread pattern.

As previously stated, in order to prevent straw from entering the ducts 36 and thus providing the potential problem of blockage of those ducts and the nozzles 44, it is desirable that the shrouding or covers over the end sections 24 be arranged to at least inhibit and possibly prevent the penetration of the straw into the areas of the end sections.

In an alternative arrangement (not shown), the end sections of the rotor may be entirely external to the straw transportation area of the combine so that the air stream through the ducts 36 is generated by separate elements of the rotor so that the ducts 36 are spaced outwardly of the straw area.

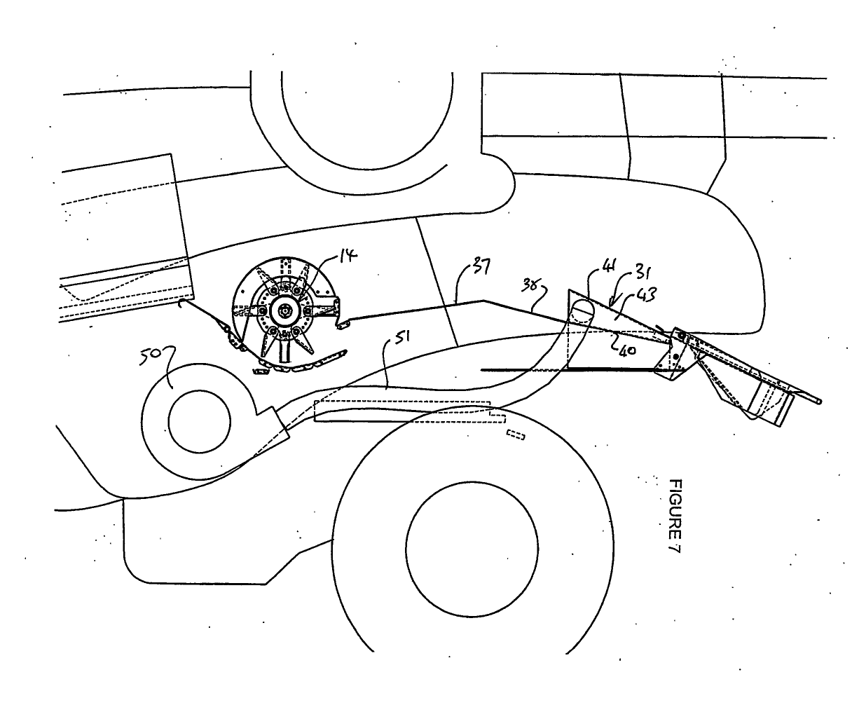

In FIG. 7 is shown a further alternative arrangement in which the supplemental air stream is generated by a fan 50 which is entirely separate from the rotor 14. In this arrangement the fan 50 generates an air stream through a duct 51 which is then transported separately from or away from the straw transportation walls 37 and 38 to the plenum 31. Thus the duct 51 enters one side wall 43 of the plenum and extends across above the bottom wall 40 of the plenum underneath the top wall 41 of the plenum and thus above the straw stream so as to feed a part of the air stream into one of the nozzles 44 and a part into the other of the nozzles 44. Thus the duct extends across the width of the plenum and is divided so as to separate the required proportions of the air stream into each of the nozzles 44.

As a further alternative, two fans can be provided either driven from the rotor directly on the end of the shaft of the rotor or by suitable drive communication from the rotor. Each of the fans then includes its own separate duct 51 transporting the air stream to the nozzle 44 of the plenum 31.

In all of these embodiments the airstream is injected into the straw stream immediately in front of the tailboard. In all of these embodiments the air stream is separated into the two separate sections each adjacent a respective side edge of the straw stream. In all of these embodiments the airstream is adjustable by butterfly valves or other suitable valving arrangements so as to adjust the airflow onto selected ones of the outermost fins of the tailboard.

In the embodiments where the supplemental air stream is separate from the chopping rotor, the chopping rotor may utilize blades which are wholly chopping blades so that they are substantially in a radial plane of the axis of the rotor to provide an improved chopping action. However some of the blades may be paddle or fan blades which assist in generating an air stream, if it is required to provide additional air stream with the straw stream exiting the rotor. It will be appreciated that the air stream for transporting the straw may be provided by different proportions of air from the supplemental air stream of the ducts 36 or 51 and from the rotor itself depending upon design requirements.

In the position of the panel or wall 38 shown in FIG. 5, the panel is pivoted downwardly so that is causes the stream of crop material carried over its surface to by-pass the fins and the plenum 31 so that the crop material is directed in its stream directly downwardly toward the ground. This avoids a spreading action when no such spreading is required by the operator.

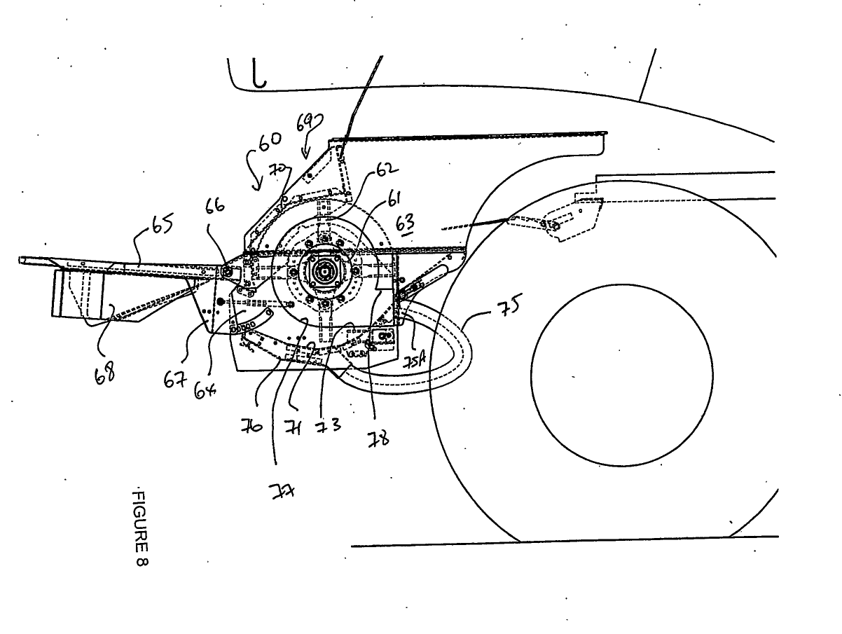

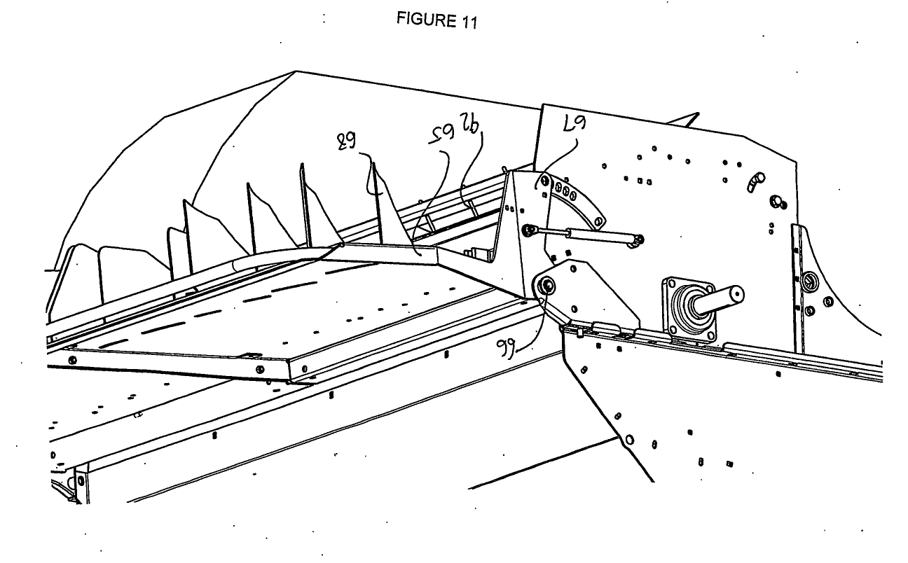

Turning now to the embodiment in FIGS. 8 through 13, there is shown a similar arrangement used with a conventional rear mounted straw chopper generally indicated at 60. The straw chopper is of a conventional nature and includes a hub 61 carrying blades 62 from an inlet 63 to an outlet 64. The tailboard 65 is mounted on pivotal movement on a transverse pivot mounting 66 and adjustable by a bracket 67. The tailboard carries fins 68. The chopper is surrounded by a housing 69 including a top wall 70 and a bottom wall 71 which confines the flow of the material from the inlet to the outlet 64 and onto the tailboard 65 and the fin 68.

As previously described the fins are mounted at varying angles across the width of the tailboard to provide the spread pattern with the fins being adjustable in inclination as previously described.

The blades 62 co-operate with stationary blades 73 in the chopping action. All these arrangements are of course conventional and well known to one skilled in the art so that the details are necessarily described since they may vary.

The blades 62 may be wholly straight chopping blades or may include paddle blades as is well known from the previous patents by Redekop defined herein.

The conventional chopper thus defined is modified by the addition of supplemental air from a duct 75 which communicates the air to a plenum 76.

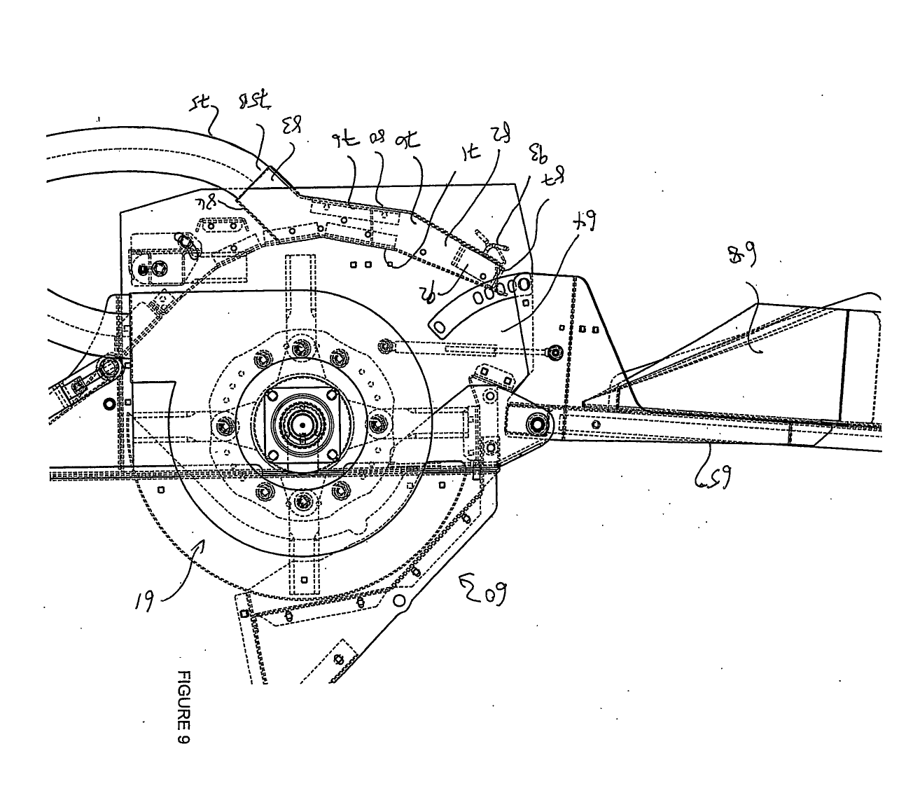

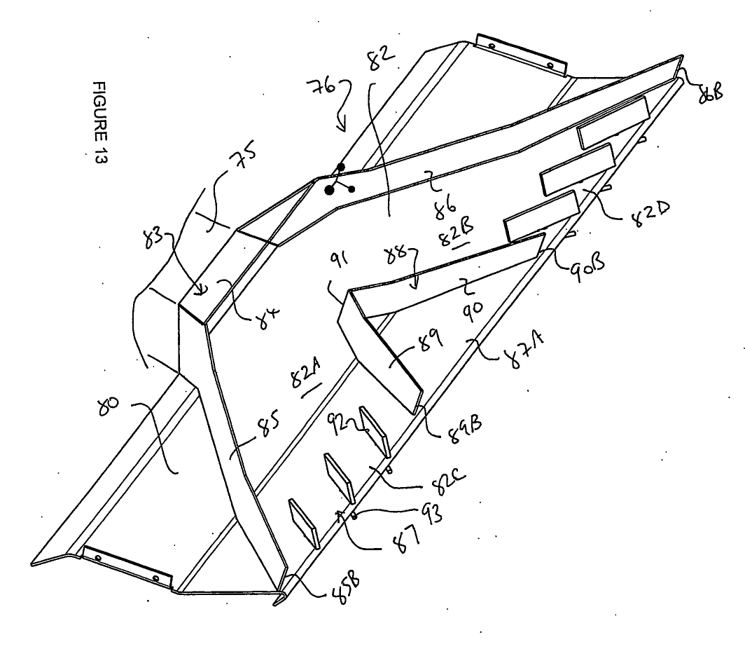

The source for the air to the duct 75 can be provided by any suitable fan arrangement driven from the combine harvester. In the example shown, the fan arrangement comprises an end fan 77 mounted on an end of the rotor and generating an air stream through an outlet nozzle 78 of the fan which enters into the open end 75A of the duct 75. However the fan maybe separate from the rotor and it may be mounted at any suitable location on the combine harvester. There may be a single fan generating air to a single duct 75 or there may be two fans generating air separately to two separate ducts 75 which feed the plenum separately. In the embodiment shown, there is a single duct 75 from a single fan mounted at one end of the rotor and the duct 75 communicates to a center location on the plenum 76. The plenum 76 is shown in more detail in FIG. 13 and in FIG. 9.

On the bottom wall 71 of the housing of the rotor 61 is mounted the plenum 76. The plenum includes a bottom wall 80 which generally follows the shape of the bottom wall 71 so that between the walls 71 and 80 is defined an air passageway 82 for the air from the duct 75. The plenum includes a connecting piece or collar 83 which is shaped to receive the end 75B of the duct 75 with the collar having an upper wall 84 which extends from the duct upwardly to the underside of the bottom wall 71 so that the upper part of the air duct 82 is closed by the wall 71 without preparation allowing air into the housing of the rotor.

The duct 82 is defined by two side walls 85 and 86 which diverge outwardly from the duct 75 and the collar 84 to define a discharge nozzle 87 at the trailing edges 85B and 86B of the walls 85 and 86. These trailing edges are spaced apart by the width of the bottom wall 71 so as to define the mouth 87 which extends to the sides of the discharge opening 64 of the straw chopper 60.

The air duct 82 is further defined a V shaped guide wall 88 defining two wall portions 89 and 90 which converge to an apex 91 and diverge to trailing edges 89B and 90B at the mouth 87. In this way the wall 85 cooperates with the wall 89 to define a first duct portion 82A and the wall 90 cooperates with the wall 86 to define a second duct portion 82B. The duct portion 82A discharges its air at a discharge mouth 82C which forms part of the mouth 87 and the duct 82B discharges air at a discharge mouth 82D. A central section 87A of the mouth 87 is free from air since it is prevented from reaching this area by the diverging walls 89 and 90. Thus again, as in the previous embodiment, the air stream is separated into two stream sections exiting from discharge nozzles 82C and 82D located underneath the bottom wall 71 at the discharge 64. Thus the mouth 87 is located underneath the discharge 64 so as to mix with the straw exiting the discharge 64 as it enters onto the tailboard 65.

The airstream through the exit nozzles 82C and 82D can be adjusted again by valves or baffles 92 on manually adjustable levers 93 similar to the butterfly valves previously described in the previous embodiment.

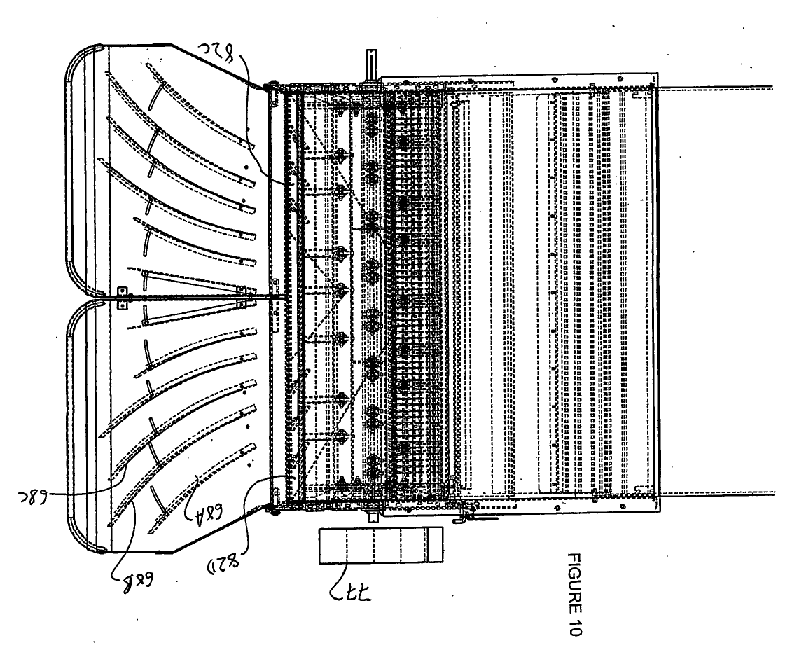

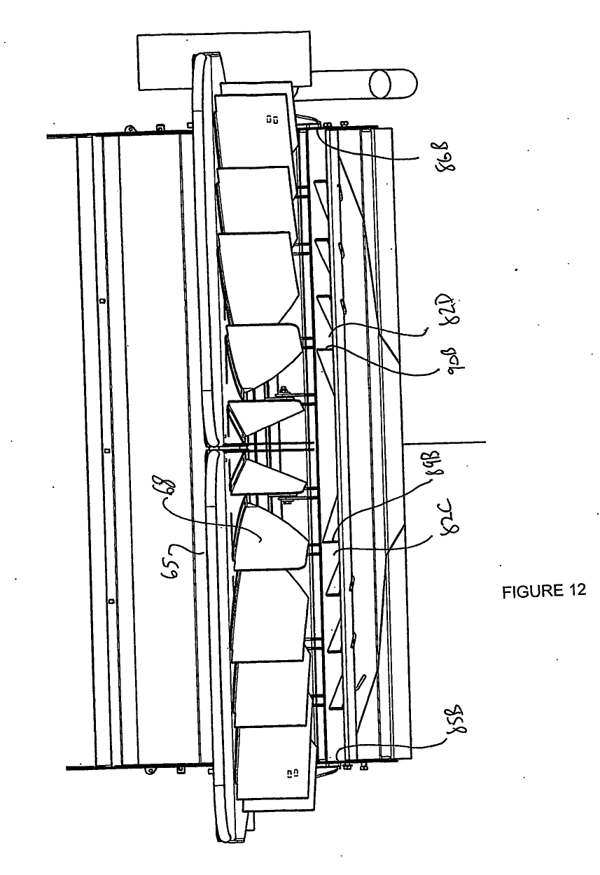

As best shown in phantom in FIG. 10, and also in the rear view of FIG. 12, the discharge nozzles 82C and 82D are arranged to direct air onto the outermost three of the fins indicated at 68A, 68B and 68C. Thus the straw entering onto these three fins has the stream air supplemented by the supplemental airstream to increase the velocity of the straw stream in these areas to again improve the spread and distribution of the straw across the spread pattern.

While the preferred embodiments of the invention have been described above, it will be recognized and understood that various modifications may be made therein, and the appended claims are intended to cover all such modifications which may fall within the spirit and scope of the invention.

1. A combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream of chopped straw for spreading the chopped straw;
the chopper and discharge apparatus having:
a rotor mounted for rotation about a longitudinal axis of the rotor and a plurality of blade members mounted on the rotor for rotation therewith about said axis for chopping the straw and accelerating the chopped materials in a stream for discharge at a discharge location;
a plurality of guide fins at the discharge location for directing the chopped materials into a spread pattern;
and a pneumatic air source for generating a stream of air through an outlet opening of an outlet nozzle forming a stream of air directed at a plurality of the guide fins for assisting the spread of the chopped materials.

2. The combine harvester according to claim 1 wherein the stream of air is arranged such that the velocity of the air is different at different ones of the guide fins.

3. (canceled)

4. The combine harvester according to claim 1 including two separate nozzles each having an outlet opening directed at a plurality of guide fins at a respective side of the discharge location.

5.-6. (canceled)

8. The combine harvester according to claim 1 wherein the exit air velocity at the outlet opening is controlled.

9. The combine harvester according to claim 1 wherein the outlet opening of the nozzle is mounted immediately adjacent the guide fins for directing the air stream onto the fins.

10. The combine harvester according to claim 1 wherein the rotor is an internal rotor within the combine housing and there is provided a guide wall extending from the rotor to the discharge location where the guide fins are located and wherein the nozzle opening is mounted at a location adjacent the fins.

11. (canceled)

12. The combine harvester according to claim 10 wherein the rotor includes two end fan sections wherein each end fan section communicates air therefrom through a duct alongside the guide wall to a separate nozzle.

13. (canceled)

14. The combine harvester according to claim 10 wherein the guide wall and the fins are arranged to include a movable element arranged to be movable from a first position directing the straw onto the fins to a second position directing the straw to by-pass the fins.

15. The combine harvester according to claim 10 wherein the movable element comprises a panel of the guide wall which is mounted for pivotal movement about a transverse axis at a leading edge of the panel so as to move a trailing edge thereof.

16. The combine harvester according to claim 15 wherein the panel is arranged in advance of the nozzle.

17.-20. (canceled)

21. A combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream chopped straw for spreading the chopped straw;
the chopper and discharge apparatus having:
an internal rotor within the combine harvester mounted for rotation about a longitudinal axis of the rotor and a plurality of blade members mounted on the rotor for rotation therewith about said axis for chopping the straw and accelerating the chopped materials in a stream for discharge at a discharge location;
a guide wall extending from the rotor to the discharge location;
a plurality of guide fins at the discharge location for directing the chopped materials into a spread pattern;
and a pneumatic air source for generating a stream of air through an outlet opening of an outlet nozzle for assisting the spread of the chopped materials;
wherein the nozzle is mounted at a location adjacent the fins and forming a stream of air directed at a plurality of the guide fins.

22. The combine harvester according to claim 21 wherein the stream of air is arranged such that the velocity of the air is different at different ones of the guide fins.

23. The combine harvester according to 21 wherein the stream of air is adjustable at different positions across the stream.

24. The combine harvester according to claim 21 wherein the rotor includes two end fan sections wherein each end fan section communicates air therefrom through a duct alongside the guide wall to a separate nozzle portion of the nozzle.

25.-36. (canceled)

37. A combine harvester comprising:
a housing;
a straw separating system mounted within the housing for separating seed materials from straw for collection of the seed materials and for transport of the straw for discharge;
a straw chopper and discharge apparatus mounted at the discharge of the straw separating system for receiving the straw for chopping the straw and for generating a stream of chopped straw for spreading the chopped straw;
the chopper and discharge apparatus having:
an internal rotor within the combine harvester mounted for rotation about a longitudinal axis of the rotor and a plurality of blade members mounted on the rotor for rotation therewith about said axis for chopping the straw and accelerating the chopped materials in a stream for discharge at a discharge location;
a guide wall extending from the rotor to the discharge location;
a plurality of guide fins at the discharge location for directing the chopped materials into a spread pattern;
wherein the guide wall and the fins are arranged to include a movable element arranged to be movable from a first position directing the straw onto the fins to a second position directing the straw to by-pass the fins.

38. The combine harvester according to claim 37 wherein the movable element comprises a panel of the guide wall which is mounted for pivotal movement about a transverse axis at a leading edge of the panel so as to move a trailing edge thereof.
